(19) United States
(12) Patent Application Publication
(10) Pub. No.: US 2009/0082535 A1
(43) Pub. Date: Mar. 26, 2009

(54) (METH)ACRYLIC ACID COPOLYMER, METHOD FOR PROCUCING THE SAME, AND APPLICATION THEREOF

(75) Inventors: Masato Nakano, Hyogo (JP); Shigeru Yamaguchi, Osaka (JP); Koji Fukuhara, Osaka (JP)

Correspondence Address: CONNOLLY BOVE LODGE & HUTZ LLP, 1875 EYE STREET, N.W., SUITE 1100, WASHINGTON, DC, 20006, US

(73) Assignee: NIPPON SHOKUBAI CO., LTD., Osaka (JP)

(21) Appl. No.: 11/910,081

(22) PCT Filed: Mar. 30, 2006
(86) PCT No.: PCT/JP2006/307277

§ 371 Date: Aug. 11, 2008

(30) Foreign Application Priority Data
Mar. 31, 2005 (JP) 2005-104257
Dec. 16, 2005 (JP) 2005-363294

(51) Int. Cl. C08F 20/06; C08F 230/04; C08F 2/16; C08F 20/26; C08F 26/02

(52) U.S. Cl. 526/234; 526/240; 526/312; 526/318.42

(57) ABSTRACT

To provide: a (meth)acrylic acid copolymer, which exhibits excellent chelating ability, dispersibility, and gel resistance, and can be preferably used in various applications, for example, in a dispersant such as an inorganic pigment and a metal ion, a detergent builder, and a water treatment agent such as a corrosion inhibitor and a scale inhibitor; and a method for producing the (meth)acrylic acid copolymer; and an application thereof. A (meth)acrylic acid copolymer having a constitutional unit (a) derived from a (meth)acrylic acid monomer (A) represented by a general formula (1) and a constitutional unit (b) derived from a hydroxyalkyl (meth)acrylate monomer (B) represented by a general formula (2),
wherein the copolymer has a sulfonic acid (sulfonate) group, and a value A of 10 or more, the value A being defined by a formula (1): A=1/(Abs−Abs0)

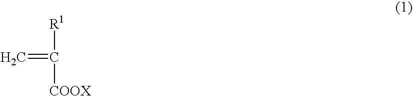

in the formula, R¹ represents a hydrogen atom or a methyl group, and X represents a hydrogen atom, a metallic atom, an ammonium group, or an organic amine group;

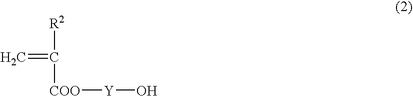

in the formula, R² represents a hydrogen atom or a methyl group, and Y represents an alkylene group containing 1 to 4 carbon atoms.

### TECHNICAL FIELD

The present invention relates to a (meth)acrylic acid copolymer, a production method and an application of the copolymer. More specifically, the present invention relates to: a (meth)acrylic acid copolymer, which can be suitably used in various applications, for example, in a dispersant such as an inorganic pigment and a metal ion, a detergent builder, and a water treatment agent such as a corrosion inhibitor and a scale inhibitor; and a method for producing the (meth)acrylic acid copolymer; and an application thereof.

### BACKGROUND ART

(Meth)acrylic acid copolymers are water-soluble polymers, and widely used in various applications. Among them, a low molecular weight (meth)acrylic acid copolymer is excellent in chelating ability or dispersibility. And such a copolymer is suitably used in various applications, for example, in a dispersant such as an inorganic pigment and a metal ion; a detergent builder; and a water treatment agent such as a corrosion inhibitor and a scale inhibitor. For example, in a cooling water system, boiler water system, a seawater desalination equipment, a pulp melting tank, or a black liquor concentration tank, a deposition (scale) of calcium carbonate, zinc phosphate, calcium phosphate, zinc hydroxide, magnesium silicate, and the like adheres to its wall, which leads to obstacles to operation, such as reduction in thermal efficiency and localized corrosion. And in order to suppress or remove such a scale, the (meth)acrylic acid copolymer is used as a corrosion inhibitor or a scale inhibitor. However, because of increasing awareness of environmental problems, recently such a copolymer is increasingly used in a high-concentrated cooling water system, or a high salt concentration water system such as sea water in order to saving resources and water, or used in a high-hardness water system due to deterioration of water quality, and the like. In these cases, the (meth)acrylic acid copolymer turns into a gel and then precipitates, failing to exhibit properties such as a scale prevention ability. Therefore, there was a room for improvement in that point.

With respect to a conventional (meth)acrylic acid copolymer, Japanese Kokai Publication Hei-11-315115 (pages 2 to 3) discloses (meth)acrylic acid copolymer produced by polymerizing a (meth)acrylic acid and a water-soluble monoethylenic unsaturated monomer in an aqueous solution, wherein the polymer has sulfonic acid groups at its terminals and less than 2.0 anti-gelling capability defined by the formula: Q=the degree of gelation×10⁵/weight-average molecular weight. This (meth)acrylic acid polymer is a low molecular weight polymer excellent in gel resistance as well as dispersibility or chelating ability, and can be preferably used in a dispersant, a scale inhibitor, a detergent builder, and the like. However, there was a room for improvement in order to be used in larger applications by further improving the gel resistance to enhance various properties such as a scale prevention ability. Recently, a water treatment agent capable of effectively acting on the high-hardness water system or the high-concentrated water system is particularly needed, and therefore there was a room for improvement in order to meet the needs.

With respect to a scale inhibitor containing a polymer having a constitutional unit introduced from a monomer containing a carboxyl group and an ethylenic unsaturated bond, Japanese Kokai Publication Sho-51-112447 (pages 1 and 4) discloses, in Example, a scale inhibitor and the like, containing an acrylic acid/2-hydroxyethyl methacrylate/methyl acrylate copolymer sodium salt as monomer components. And Japanese Kokai Publication Sho-58-171576 (page 1) discloses the scale inhibitor further containing tungstic acid, or molybdic acid or salt thereof. However, these scale inhibitors have room for improvement in order to exhibit sufficient effect in the high-hardness water system, which is recently needed, by sufficiently improving a gel resistance.

Further, Japanese Kokoku Publication Sho-60-24806 (page 1) discloses a production method of a low molecular weight acrylate polymer, the method comprising an aqueous polymerization of continuously adding an acrylate monomer containing (A) an acrylic acid alkali metal salt, (B) a monomer such as acrylamide, and (C) a hydrophilic monomer, and sodium hydrogen sulfite at 80° C. or less while blowing air into the system. This method allows for a highly efficient production of a low molecular weight acrylate polymer, which is useful as a dispersant or a scale inhibitor and hardly colored. However, the method has room for improvement in order to produce the polymer with high efficiency by further improving various properties such as dispersibility, chelating ability, and gel resistance, and by further reducing impurities during the production processes.

### SUMMARY OF THE INVENTION

The present invention has been made in view of the above-mentioned state of the art. And the present invention has an object to provide: a (meth)acrylic acid copolymer, which exhibits excellent chelating ability, dispersibility, and gel resistance, and can be preferably used in various applications, for example, in a water treatment agent such as a scale inhibitor and a corrosion inhibitor, a dispersant, and a detergent builder; and a production method of the (meth)acrylic acid copolymer; and an application thereof.

The present inventors have made various investigations about (meth)acrylic acid copolymers. They have found that gel resistance is improved, and therefore properties such as dispersibility, chelating ability and scale prevention ability can be sufficiently exhibited if a sulfonic acid group is introduced into a copolymer having a constitutional unit derived from a (meth)acrylic acid monomer (A) and a constitutional unit derived from a hydroxyalkyl (meth)acrylate monomer (B). They have further found that such a (meth)acrylic acid copolymer can sufficiently act in a high-concentrated water system, a high-hardness water system, or a high salt concentration water system, if a value A represented by 1/(Abs−Abs0) is specified. And they have found that a scale inhibitor containing such a copolymer is especially useful. Thereby the above-mentioned problems have been solved. They have also found that a productivity of the copolymer is significantly improved and the copolymer is able to be produced with high efficiency, if a solid concentration in an aqueous solution upon completion of a polymerization reaction is set to 40% by weight (weight %, mass % or % by mass) or more, or a polymerization reaction is performed using sulfite as a chain transfer agent, in the method for producing the (meth)acrylic acid copolymer. Thereby, the present invention has been completed.

That is, the present invention relates to a (meth)acrylic acid copolymer having a constitutional unit (a) derived from a (meth)acrylic acid monomer (A) represented by a general formula (1) and a constitutional unit (b) derived from a hydroxyalkyl (meth)acrylate monomer (B) represented by a general formula (2),

wherein the copolymer has a sulfonic acid (sulfonate) group, and a value A of 10 or more, the value A being defined by a formula (1): A=1/(Abs−Abs0)

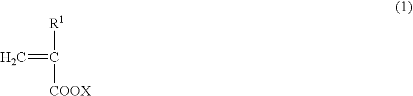

in the formula, R¹ represents a hydrogen atom or a methyl group, and X represents a hydrogen atom, a metallic atom, an ammonium group, or an organic amine group;

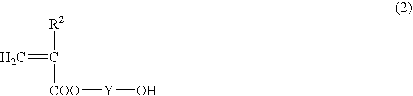

in the formula, R² represents a hydrogen atom or a methyl group, and Y represents an alkylene group containing 1 to 4 carbon atoms.

The present invention will be, hereinafter, described in more detail.

The (meth)acrylic acid copolymer of the present invention has a constitutional unit (a) derived from a (meth)acrylic acid monomer (A) represented by a general formula (1) and a constitutional unit (b) derived from a hydroxyalkyl (meth)acrylate monomer (B) represented by a general formula (2). These constitutional units (a) and (b) each may be one kind or may be two or more kinds. And the copolymer further has one or more kinds of a constitutional unit (c) derived from an another monomer (C) copolymerizable with the monomers (A) and/or (B). These constitutional units are not especially limited as long as the (meth)acrylic acid copolymer has these constitutional units. For example, these constitutional units may be those which generate when the above-mentioned (meth)acrylic monomer (A) or hydroxyalkyl (meth)acrylate monomer (B) is used as a monomer component, or generate during the reaction.

In the above-mentioned (meth)acrylic acid copolymer, the constitutional unit (a) corresponds to a structure, in which a polymerizable double bond in the (meth)acrylic monomer (A) is opened by the polymerization reaction (a structure, in which the double bond (C═C) becomes a single bond (—C—C—)); the constitutional unit (b) corresponds to a structure, in which a polymerizable double bond in the hydroxyalkyl (meth)acrylate monomer (B) is opened by the polymerization reaction; and the constitutional unit (c) corresponds to a structure in which a polymerizable double bond in the another monomer (C) copolymerizable with the monomers (A) and/or (B) is opened by the polymerization reaction.

In the (meth)acrylic monomer (A) represented by the above-mentioned general formula (1), X represents a hydrogen atom, a metallic atom, an ammonium group, or an organic amine group. As the metallic atom, for example, lithium, sodium, and potassium may be mentioned. As the organic amine group (protonated organic amine), monoethanolamine, diethanolamine, triethanolamine, and the like may be mentioned.

Specific examples of the (meth)acrylic acid monomer (A) include acrylic acid, methacrylic acid, and salts thereof (for example, sodium salt, potassium salt, ammonium salt). Especially, acrylic acid and sodium acrylate are preferred. Only one kind or two or more kinds of them may be used.

Examples of the above-mentioned hydroxyalkyl (meth)acrylate monomer (B) include one or more of 2-hydroxyethyl (meth)acrylate, 2-hydroxypropyl (meth)acrylate, 3-hydroxypropyl (meth)acrylate, 2-hydroxybutyl (meth)acrylate, 4-hydroxybutyl (meth)acrylate, and α-hydroxymethyl ethyl (meth)acrylate.

It is preferable that the above-mentioned (meth)acrylic acid copolymer has the constitutional units (a) and (b) such that a ratio of the constitutional unit (a) to the constitutional unit (b) is 30 to 95% by mole to 5 to 70% by mole. If the ratio of the constitutional unit (a) to the constitutional unit (b) is set to the above-mentioned range, gelation of the copolymer is sufficiently suppressed and thereby the copolymer can sufficiently exhibit performance as a scale inhibitor and the like, for example, if the copolymer is used as a scale inhibitor in a water system containing much hardness components such as calcium ion. If the constitutional unit (a) exceeds the range and the constitutional unit (b) is less than the range, gel resistance might not be improved. And if the constitutional unit (a) is less than the range and the constitutional unit (b) exceeds the range, chelating ability or dispersibility might be insufficiently exhibited. More preferably, the constitutional unit (a) is 60 to 95% by mole, and the constitutional unit (b) is 5 to 40% by mole.

A total of the constitutional unit (a) and the constitutional unit (b) in the (meth)acrylic acid copolymer has a ratio of 50 to 100% by mole, based on 100% by mole of the whole copolymer. More preferably, the ratio is 70 to 100% by mole.

The above-mentioned (meth)acrylic acid copolymer may have the constitutional unit (c) derived from the another copolymer copolymerizable with the monomers (A) and/or (B), other than the constitutional units (a) and (b), as mentioned above. It is preferable that the copolymer has 50% by mole or less of the constitutional unit (c), based on 100% by mole of the whole copolymer. More preferably, the copolymer has 30% by mole or less of the constitutional unit (c).

The monomer (C) that provides such a constitutional unit (c) is not especially limited as long as the monomer (C) is copolymerizable with the (meth)acrylic acid monomer (A) and/or the hydroxyalkyl (meth)acrylate monomer (B). Examples of the monomer (C) include (meth)allyl ether monomers such as 3-(meth)allyloxy-2-hydroxy-1-propanesulfonic acid, and 3-(meth)allyloxy-1-hydroxy-2-propanesulfonic acid, 3-(meth)allyloxy-1,2-dihydroxypropane, a compound prepared by adding 1 to 200 mole of ethylene oxide to 3-(meth)allyloxy-1,2-dihydroxypropane (for example, 3-allyloxy-1,2-di(poly)oxyethylene ether propane) and salts thereof; sulfonic acid monomers, for example, conjugated diene sulfonic acids such as 2-(meth)acrylamide-2-methylpropane sulfonic acid, (meth)allyl sulfonic acid, vinyl sulfonic acid, styrene sulfonic acid, 2-sulfoethyl (meth)acrylate, and 2-methyl-1,3-butadiene-1-sulfonic acid, and salts thereof; N-vinyl monomers such as N-vinyl pyrrolidone, N-vinyl formamide, N-vinyl acetamide, N-vinyl-N-methyl formamide, N-vinyl-N-methyl acetamide, and N-vinyl oxazolidone; amide monomers such as (meth) acrylamide, N,N-dimethyl acrylamide and N-isopropyl acrylamide; unsaturated dicarboxylic acids such as itaconic acid, fumaric acid, and maleic acid, and salts thereof; (meth)allyl alcohol monomers such as (meth)allyl alcohol, and a compound prepared by adding 1 to 100 mole of ethylene oxide to (meth)allyl alcohol; (meth)acrylic ester monomers such as methyl (meth)acrylate, ethyl (meth)acrylate, and butyl (meth)acrylate; and isoprene monomers such as isoprenol, and a compound prepared by adding 1 to 100 mole of ethylene oxide to isoprenol. These monomers may be used singly or in combination.

The (meth)acrylic acid copolymer of the present invention has a sulfonic acid (sulfonate) group. Such a copolymer having a sulfonic acid (sulfonate) group has sufficiently improved gel resistance, and thereby can sufficiently exhibit chelating ability or dispersibility in a high-hardness or high-concentrated water system. Therefore, such a copolymer can meet today's needs. The sulfonic acid (sulfonate) group means a sulfonic acid group or a sulfonate group. And as the sulfonate group, mentioned may be a group containing a sulfonic acid and an ammonium salt, an alkali metal salt or an organic amine. As an alkali metal of the alkali metal salt, for example, lithium, sodium, and potassium may be mentioned. As the organic amine, monoethanolamine, diethanolamine, triethanolamine may be mentioned.

The copolymer may have such a sulfonic acid group at a side chain or at a terminal of the main chain, but preferably at least one terminal of the main chain. Such a form in which the copolymer has the sulfonic acid group at least one terminal of the main chain is part of preferable embodiment of the present invention. The copolymer may have the sulfonic acid groups at both terminals of the main chain. Whether or not the above-mentioned (meth)acrylic acid copolymer has the sulfonic acid group at least one terminal of the main chain can be identified by measuring the copolymer for ¹H-NMR (nuclear magnetic resonance) using heavy water as a solvent.

The (meth)acrylic acid copolymer having the above-mentioned sulfonic acid group can be produced by, for example, a polymerization reaction using a monomer component containing a sulfonic acid group, or a polymerization reaction using sulfite as a chain transfer agent. Particularly the polymerization reaction using sulfite as a chain transfer agent is preferred because the sulfonic acid group can be introduced at least one terminal of the main chain. The production method is as mentioned below.

In the above-mentioned (meth)acrylic acid copolymer, it is preferable that the copolymer has a value A of 10 or more, the value A (a gel resistance value A) being defined by the formula (1): A=1/(Abs−Abs0). If the value A is less than 10, the (meth)acrylic acid copolymer quite easily turns into a gel due to a calcium ion and the like. The gelled (meth)acrylic acid copolymer loses a water solubility and precipitates to lose properties such as dispersibility. Therefore, such a copolymer might not be preferably used as a water treatment agent in a water system containing relatively less hardness components such as calcium ion. The value A is preferably 100 or more. If the value A is less than 100, the (meth)acrylic acid copolymer easily turns into a gel due to a calcium ion and the like. The gelled (meth)acrylic acid copolymer loses the water solubility and precipitates to lose properties such as dispersibility. Therefore, such a copolymer might not be preferably used as a water treatment agent in a water system containing much hardness components such as calcium ion. Preferable embodiment of the present invention also includes a (meth)acrylic acid copolymer having a constitutional unit (a) derived from a (meth)acrylic acid monomer (A) represented by a general formula (1) and a constitutional unit (b) derived from a hydroxyalkyl (meth)acrylate monomer (B) represented by a general formula (2), wherein the copolymer has a sulfonic acid (sulfonate) group and a value A of 100 or more, the value A being defined by a formula (1): A=1/(Abs−Abs0).

It is preferable that the above-mentioned value A is 100 or more. The above-mentioned value A is more preferably 200 or more and still more preferably 300 or more. The higher the value A is, the better. There is especially no upper limit on the value A, but the (meth)acrylic acid copolymer having 10000 or more of the value A is enough to be used as a water treatment agent. The higher gel resistance value A the copolymer has, the less the copolymer turns into a gel due to bond to a calcium ion. For example, the copolymer showing a high gel resistance value can exhibit excellent performances as a scale inhibitor to water with high calcium hardness.

In the above formula (1), “Abs” means a UV absorbance value of the above-mentioned (meth)acrylic acid copolymer at a UV (ultraviolet radiation) wavelength of 380 nm. And “Abs0” means a UV absorbance value of a blank at a UV wavelength of 380 nm. These UV absorbance values can be evaluated by the following method.

### [Measurement of UV Absorbance Value]

To a 500 mL tall beaker are added desalted water, boric acid-sodium borate pH buffer solution, a (co)polymer aqueous solution, and an aqueous solution of calcium chloride in this order, to adjust pH to 8.6, a (co)polymer concentration to 100 mg/L on a solid matter equivalent basis, and a calcium hardness to 500 mgCaCO₃/L. This test solution is kept standing on a incubator at 90° C. for 1 hour. And the test solution is stirred and put into a 5 cm quartz cell, and then measured for absorbance value Abs at a UV wavelength of 380 nm. As a blank, a test solution prepared by removing calcium chloride from the above-mentioned test solution is prepared. And then the blank is measured for absorbance value Abs0 after the above operations.

The above-mentioned (meth)acrylic acid copolymer, as mentioned above, has the constitutional unit (a), the constitutional unit (b), and the sulfonic acid (sulfonate) group, and has the value A of 10 or more, the value A being defined by the above-mentioned formula (1). Further, it is preferable that the (meth)acrylic acid copolymer has a clay dispersibility for JIS test powders I Class 11 of 0.55 or more, or a clay dispersibility for JIS test powders I Class 8 of 0.97 or more. The copolymer having such a clay dispersibility more effectively prevents a precipitation of dirts, dusts, or the like, and thereby can be preferably used in various applications, such as in a water treatment agent. The clay dispersibility is mentioned below. As mentioned above, preferable embodiment of the present invention also includes the above-mentioned (meth)acrylic acid copolymer, wherein the copolymer has a clay dispersibility for JIS test powders I Class 11 of 0.55 or more, or a clay disperiability for JIS test powders I Class 8 of 0.97 or more in an aqueous solution with a calcium hardness of 200 mgCaCO₃/L.

The present invention also relates to a (meth)acrylic acid copolymer having a constitutional unit (a) derived from a (meth)acrylic acid monomer (A) represented by a general formula (1) and a constitutional unit (b) derived from a hydroxyalkyl (meth)acrylate monomer (B) represented by a general formula (2),

wherein the copolymer has a sulfonic acid (sulfonate) group and a clay dispersibility for JIS test powders I Class 11 of 0.55 or more, or a clay dispersibility for JIS test powders I Class 8 of 0.97 or more in an aqueous solution with a calcium hardness of 200 mgCaCO₃/L,

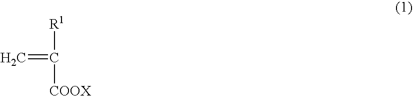

in the formula, R¹ represents a hydrogen atom or a methyl group, and X represents a hydrogen atom, a metallic atom, an ammonium group, or an organic amine group

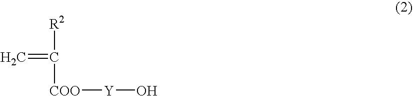

in the formula, R² represents a hydrogen atom or a methyl group, and Y represents an alkylene group containing 1 to 4 carbon atoms.

Preferred examples of the constitutional unit (a), the constitutional unit (b), and the sulfonic acid (sulfonate) group in the above-mentioned (meth)acrylic acid copolymer are as mentioned above.

The above-mentioned clay dispersibility means a barometer indicating the following preventive effects of the copolymer in a case mentioned below. For example, in an open-circulating cooling water system, dirts or dusts existing in open air are introduced into cooling water, when the cooling water is cooled by open air in a cooling tower to remove heat of vaporization. In this case, when the copolymer is added into the cooling water, the copolymer disperses the dirts or dusts uniformly to prevent: precipitation at the pipe and the like; energy loss caused by the precipitation, which narrows a flow channel of the water cooling system; and destruction of the cooling water system caused by the precipitation, which blocks the pipe and the like. The JIS test powders I Class 11 and the JIS test powders I Class 8 used in the evaluation of the above-mentioned clay dispersibility each contain silica as a main component, and the silica accounts for about 40% of the chemical composition. Industrial water used for cooling water often contains silica. For example, when cooling water is circulated and used in an open-circulating cooling water, silica concentrated in the cooling water may deposit as a scale on a pipe and the like. The above-mentioned clay dispersibility also means a barometer indicating the following preventive effect of the copolymer in the above case. When the copolymer is added into the cooling water and the like, the copolymer disperses the deposited silica to prevent: reduction in heat exchange efficiency caused by the silica, which adheres to a heat exchanger surface; energy loss caused by the silica, which precipitates at the pipe and the like and narrows a flow channel of the water cooling system; and destruction of the cooling water system caused by the silica, which blocks the pipe and the like. The value of the clay dispersibility referred to herein is a value determined by the following methods and under the following conditions. More specifically, the value include a value of dispersibility for JIS test powders I Class 8 in a test solution with a calcium hardness of 200 mgCaCO₃/L (hereinafter, referred to as clay dispersibility for JIS test powders I Class 8), and a value of dispersibility for JIS test powders I Class 11 in a test solution with a calcium hardness of 200 mgCaCO₃/L (hereinafter, referred to as clay dispersibility for JIS test powders I Class 11). In the above-mentioned clay dispersibility for JIS test powders I Class 11 or clay dispersibility for JIS test powders I Class 8, as the clay dispersibility is higher, a higher dispersibility is exhibited in various applications such as in a water treatment agent. And the higher the clay dispersibility is, the better. The above-mentioned JIS test powders I Class 11 and JIS test powders I Class 8 can be preferably used for evaluating the clay dispersibility, because they are stable and easily available.

The above-mentioned clay dispersibility for JIS test powders I Class 11 is preferably 0.55 or more. If the above-mentioned clay dispersibility is less than 0.55, the effect of preventing the precipitation of dusts or dirts may be reduced. The clay dispersibility is more preferably 0.58 or more, and still more preferably 0.60 or more.

The above-mentioned clay dispersibility for JIS test powders I Class 8 is preferably 0.97 or more. If the clay dispersibility is less than 0.97, the effect of preventing the precipitation of dusts or dirts may be reduced. The clay dispersibility is more preferably 0.98 or more, and still more preferably 0.99 or more. As mentioned above, preferable embodiment of the present invention also include a form in which the above-mentioned (meth)acrylic acid copolymer has a clay dispersibility for JIS test powders I Class 11 of 0.55 or more, or a clay dispersibility for JIS test powders I Class 8 of 0.97 or more in an aqueous solution with a calcium hardness of 200 mgCaCO₃/L.

[Measurement of Clay Dispersibility for JIS Test Powders I Class 11]

Pure water is added to glycine 67.56 g, sodium chloride 52.6 g, and NaOH 2.4 g to prepare a mixture 600 g (this mixture is referred to as a buffer A). Into the buffer A 60 g are added calcium chloride dihydrate 0.3268 g and further pure water to prepare a mixture 1000 g (this mixture is referred to as a buffer B). The buffer B 27 g is added to an aqueous solution of 0.02% by weight of a copolymer to be measured (on a part by weight of solid matter equivalent basis) 3 g and the mixture is stirred to prepare a dispersing solution. Into a test tube (product of IWAKI GLASS Co., Ltd: 18 mm in diameter, and 180 mm in height) is charged JIS test powders I Class 11 (product of The Association of Powder Process Industry and Engineering, JAPAN, test dusts Class 11) 0.3 g and then the above-mentioned dispersing solution 30 g is added and then the test tube is sealed. These conditions make the solution have a calcium hardness of 200 mgCaCO₃/L.

The test tube is shaken to disperse the clay uniformly. Then, the test tube is kept standing in the dark for 3 hours at room temperatures (about 20° C.). After 3 hours, 5 cc of supernatant is taken from the dispersing solution and measured for absorbance with UV spectroscope (produced by Shimadzu Corp. UV-1200; 1 cm cell, at a wavelength of 380 nm). The measured value is defined as clay dispersibility for JIS test powders I Class 11. The higher the value is, the higher the clay dispersibility for JIS test powders I Class 11 is.

[Measurement of Clay Dispersibility for JIS Test Powders I Class 8]

Pure water is added to glycine 67.56 g, sodium chloride 52.6 g, and NaOH 2.4 g to prepare a mixture 600 g (this mixture is referred to as a buffer A). Into the buffer A 60 g are added calcium chloride dihydrate 0.3268 g and further pure water to prepare a mixture 1000 g (this mixture is referred to as a buffer B). The buffer B 27 g is added to an aqueous solution of 0.02% by weight of a copolymer to be measured (on a part by weight of solid matter equivalent basis) 3 g and the mixture is stirred to prepare a dispersing solution. Into a test tube (product of IWAKI GLASS Co., Ltd: 18 mm in diameter, and 180 mm in height) is charged JIS test powders I Class 8 (product of The Association of Powder Process Industry and Engineering, JAPAN, test dusts Class 8) 0.3 g and then the above-mentioned dispersing solution 30 g is added and then the test tube is sealed. These conditions make the solution have a calcium hardness of 200 mgCaCO₃/L.

The test tube is shaken to disperse the clay uniformly. Then, the test tube is kept standing in the dark for 5 hours at room temperatures (about 20° C.). After 5 hours, 5 cc of supernatant is taken from the dispersing solution and measured for absorbance with UV spectroscope (produced by Shimadzu Corp. UV-1200; 1 cm cell, at a wavelength of 380 nm). The measured value is defined as clay dispersibility for JIS test powders I Class 8. The higher the value is, the higher the clay dispersibility for JIS test powders I Class 8 is.

As mentioned above, the above-mentioned (meth)acrylic acid copolymer has the constitutional unit (a), the constitutional unit (b) and the sulfonic acid (sulfonate) group, and has a clay dispersibility for JIS test powders I Class 11 of 0.55 or more, or a clay dispersibility for JIS test powders I Class 8 of 0.97 or more. And the above-mentioned (meth)acrylic acid copolymer has a value of 10 or more, the value A being defined by the following formula (1). The copolymer having such a value A can be preferably used in various applications, such as a water treatment agent because the gelling of the (meth)acrylic acid copolymer caused by a calcium ion and the like is suppressed. The value A is as mentioned above. As mentioned above, preferable embodiment of the present invention also includes a form, in which the copolymer has a value A of 10 or more, the value A being defined by the formula (1): A=1/(Abs−Abs0).

It is preferable that the above-mentioned (meth)acrylic acid copolymer has a weight-average molecular weight of from 500 as a lower limit to 50000 as an upper limit. The (meth)acrylic acid copolymer having a weight-average molecular weight within the above range can sufficiently exhibit both properties of chelating ability and dispersibility. If the weigh-average molecular weight is less than 500, the chelating ability is insufficient. And if the weight-average molecular weight is more than 50000, the dispersibility might not be improved. Therefore, in each case, a desired performance might be insufficiently exhibited in various applications, for example, in a scale inhibitor, a corrosion inhibitor, a dispersant, and a detergent builder. The lower limit is more preferably 1000, and still more preferably 2000. And the upper limit is more preferably 30000, and still more preferably 20000.

If the above-mentioned (meth)acrylic acid copolymer has a weight-average molecular weight satisfying the above range, the copolymer is preferably used as a scale inhibitor for inhibiting various scales of such as zinc phosphate, calcium carbonate, calcium phosphate, silicic acid soda, silica, and iron salt. For inhibiting a scale of the calcium carbonate, the copolymer having a lower weight-average molecular weight is most effective.

The weight-average molecular weight can be determined with, for example, Gel permeation chromatography (produced by Showa Denko K.K. tradename “Shodex-GPC SYSTEM-21”) under the following conditions.

### (Measurement Condition of Weight-Average Molecular Weight)

Column: prepared by connecting “Asahipak GF-710 HQ” and “Asahipak GF-310 HQ” products by Showa Denko K.K. in this order
Eluent: 0.1N sodium acetate/acetonitrile=7/3 (vol ratio)
Flow rate: 0.5 ml/min

### Temperature: 40° C.

Calibration curve: drawn using a polyethylene glycol standard sample (product of GL Sciences Inc.)

As a method of producing the (meth)acrylic acid copolymer of the present invention, mentioned may be a copolymerization of monomer components having, as essential components, the (meth)acrylic acid monomer (A) providing the constitutional unit (a) and the hydroxyalkyl (meth)acrylate monomer (B) providing the constitutional unit (b). And when the monomer components are copolymerized, the above-mentioned another monomer (C) copolymerizable with the monomer(s) (A) and/or (B) may be further copolymerized, if necessary.

In such a production method, the monomer components may be copolymerized using a polymerization initiator. The kind and the amount to be used of the monomer contained in the monomer components are appropriately determined such that the (meth)acrylic acid copolymer is constituted as mentioned above.

The copolymerization may be performed by the method commonly used, for example, solution polymerization, bulk polymerization, suspension polymerization, or emulsion polymerization, and the copolymerization method is not especially limited. A solvent used in the copolymerization is not especially limited, and water or a lower alcohol with 1 to 4 carbon atoms such as isopropyl alcohol is preferably used. The solvent may be a single solvent or a mixed solvent. Among them, water is more preferably used as the solvent because of no need for a solvent removal step.

The polymerization initiator in the above-mentioned copolymerization reaction is not especially limited. Examples of the polymerization initiator include one or more of following compound(s): an azo compound such as 2,2-azobis(2-aminopropane) hydrochloride and 2,2-azobis[2-methyl-N-(2-hydroxyethyl)-propione amide]; a peroxide such as hydrogen peroxide and tert-butyl hydroxy peroxide. Among them, a persulfate is preferably used such as sodium persulfate, potassium persulfate, and ammonium persulfate in terms of improvement in polymerization degree and reduction in amount of residual monomer.

The amount to be used of the above-mentioned polymerization initiator is not especially limited. For example, it is preferable that a lower limit of the amount to be used is 0.001% by weight, and an upper limit thereof is 10% by weight, relative to 100% by weight of the whole monomer component.

It is preferable that sulfite is used in the above-mentioned copolymerization reaction. Thereby, a sulfonic acid group can be quantatively introduced at a terminal of a main chain of a (meth)acrylic acid copolymer to be obtained, and thereby gel resistance can be sufficiently improved. As mentioned above, a method for producing the (meth)acrylic acid copolymer, wherein the method comprises a process for performing a polymerization reaction using sulfite, is part of the present invention. What the sulfonic acid group can be quantatively introduced indicates that the sulfite functions very well as a chain transfer agent. Thereby, an excessive chain transfer agent has no need to be added in the polymerization reaction system. Therefore, increase in production costs of the copolymer is reduced, production efficiency is improved, and impurities can be sufficiently reduced. And the addition of the sulfite into the polymerization reaction system can suppress a copolymer to be obtained from having a high molecular weight more than necessary.

Examples of the sulfite include one or more of sodium hydrogensulfite, potassium hydrogensulfite, ammonium hydrogensulfite, sodium sulfite, potassium sulfite, and ammonium sulfite. Among them, sodium hydrogensulfite is most preferred. Another chain transfer agent usually used may be used in combination with the sulfite.

In an amount to be used of the above-mentioned sulfite, a lower limit is 2% by mole, and an upper limit is 15% by mole, relative to 100% by mole of the whole monomer component. If the amount to be used is less than 2% by mole, the sulfonic acid group may not be quantatively introduced at a terminal of the main chain of the copolymer. If the amount to be used is more than 15% by mole an excessive sulfite is dissolved in a reaction system to generate sulfurous acid gas, which may be economic disadvantage. More preferably, the lower limit is 3% by mole, and the upper limit is 10% by mole.

A polymerization auxiliary may be used together with the above-mentioned chain transfer agent and polymerization initiator in the above-mentioned copolymerization. As the polymerization auxiliary, used may be a transition metal compound such as iron and Mohr's salt (ammonium iron (II) sulfate hexahydrate); a mercapto compound such as a mercaptoethanol and mercaptopropionic acid; and ascorbic acid salt. The polymerization auxiliary may be previously charged into the reaction system. And it is preferable that an amount to be added of the polymerization auxiliary is usually 0.1 ppm to 50 ppm in the transitional metal compound, and 0.1% by weight to 5% by weight in the mercapto compound, ascorbic acid salt, or the like, relative to the whole monomer component. As the chain transfer agent used in the above-mentioned copolymerization reaction, the sulfite is preferably used, as mentioned above. However, the chain transfer agent is not especially limited as long as the (meth)acrylic acid copolymer of the present invention can be obtained. One or more of the above-mentioned another chain transfer agent usually used may be used. For example, if the above-mentioned chain transfer agent is independently used, a desired copolymer can be produced by appropriately adjusting the production conditions.

It is also preferable that the above-mentioned copolymerization reaction is performed under an acid condition. More specifically, the copolymerization is performed under pH less than 5 condition and a neutralization degree of less than 40% by mole. If the copolymerization is performed under an acid condition as mentioned above, a low molecular weight polymer can be produced well without increase in viscosity of an aqueous solution in a polymerization reaction system. And the polymerization reaction is allowed to proceed under a higher concentration condition than ever before as mentioned below. Therefore, production efficiency can be significantly improved. Also, a high concentration polymerization can be performed in one step, and therefore a concentration step, which might be needed in conventional production methods, can be omitted. Therefore, productivity in the (meth)acrylic acid copolymer can be sufficiently improved, leading to suppression of increase in production costs. More preferably, the polymerization reaction is performed under conditions of pH less than 5 and a neutralization degree of less than 40% by mole. The neutralization degree is more preferably less than 30% by mole, and still more preferably less than 20% by mole.

The copolymer produced by the above-mentioned copolymerization method can be used as it is as a main component of a scale inhibitor. However, the copolymer may be used after further neutralized with an alkali substance, if necessary. As the alkali substance, preferably used are an inorganic salt such as a hydroxide, chloride, and carbonate of a monovalent metal and a divalent metal; ammonia; and organic ammonium (organic amine).

A reaction temperature at the time of the copolymerization in the above-mentioned copolymerization reaction is not especially limited. For example, the reaction temperature is preferably 50 to 150° C. If the reaction temperature is less than 50° C., a copolymerization reactivity is insufficient, and therefore unreacted monomers might be insufficiently reduced. If the reaction temperature is more than 150° C., a side reaction can be insufficiently suppressed, and therefore the reaction might not be easily controlled. The reaction temperature is more preferably 70 to 120° C., and still more preferably 80 to 110° C. The above-mentioned copolymerization reaction may be performed under inert gas atmosphere, such as nitrogen and argon, or under the air.

In the above-mentioned copolymerization reaction, it is preferable that each of the monomer components, the sulfite, and the polymerization initiator may be separately added dropwise continuously for each predetermined drop time, or may be each charged in portions. The drop time may be appropriately determined, and preferably 30 to 480 minutes, for example. If the drop time is too long, the productivity might be insufficient. If the drop time is too short, the sulfonic acid group might not be effectively introduced at a terminal of the copolymer, for example. More preferably, the drop time is 45 to 240 minutes. A drop rate is not especially limited. The drop rate may be constant from start to end of the drop, or may be varied with time, if necessary. It is not especially limited when to start and finish the drop of each of the monomer components, the sulfite, and the polymerization initiator. For example, the drop of the sulfite may start earlier than each of the monomer components or the polymerization initiator, or the drop of all of them may be simultaneously started.

In the above-mentioned copolymer reaction, it is preferable that upon completion of a polymerization reaction, the aqueous solution has a solid concentration, that is, the polymerization reaction system has a concentration of solid components (for example a solid concentration of a monomer) of 40% by weight or more. Thereby, production efficiency of the copolymer can be significantly improved. The solid concentration is more preferably 45% by weight, and still more preferably 50% by weight. As mentioned above, a method for producing the (meth)acrylic acid copolymer, wherein an aqueous solution upon completion of a polymerization reaction has a solid concentration of 40% by weight or more, is part of the present invention.

The above-mentioned “upon completion of a polymerization reaciton” may be after completion of the drop of each component. More specifically, it may be after the reaction solution into which each of the above-mentioned components has been added dropwise is further maintained (matured) at 90° C. or under a boiling point for 30 minutes.

As mentioned above, it is preferable that the copolymerization reaction is performed under an acid condition in the present invention. Thereby, increase in viscosity of the reaction solution can be sufficiently suppressed if the polymerization reaction proceeds. Therefore, a low molecular weight polymer can be produced if the polymerization reaction is performed under a high concentration condition.

A method for charging each of the above-mentioned monomer components into a reactor is not especially limited. Examples of the method include a method of charging a total amount of the components into a reactor in early stages; a method of charging a total amount of the components into a reaction in portions or continuously; a method of charging part of the components into a reactor in early stages, and then changing the rest of the components into the reactor in portion or continuously. Specific examples of preferable charging method include the following (1) to (3) methods:

(1) a method of continuously charging a total amount of the monomers (A) and (B) into a reactor;
(2) a method of charging part of the monomer (A) into a reactor in early stages, and then charging the rest of the monomer (A) and a total amount of the monomer (B) into the reactor continuously; and
(3) a method of charging part of the monomer (A) and part of the monomer (B) into a reactor in early stages, and then charging the rest of the monomer (A) and the rest of the monomer (B) alternatively into the reactor in several portions.

Thus-produced (meth)acrylic acid copolymer can be used in various applications as it is. However, the (meth)acrylic acid copolymer may be used after further neutralized with an alkali substance, if necessary. Examples of the alkali substance include a hydroxide, chloride, and carbonate of an alkaline metal such as sodium and potassium; a hydroxide, chloride, and carbonate of an alkaline earth metal such as calcium and magnesium; ammonia; and an organic amine such as monoethanolamine, diethanolamine, and triethanolamine. These are used singly or in combination.

The (meth)acrylic acid copolymer of the present invention is particularly excellent in chelating ability, dispersibility, or gel resistance as mentioned above. Therefore, the copolymer can be preferably used in various applications, for example, a scale inhibitor and a corrosion inhibitor in a cooling water system, a boiler water system, a geothermal water system, an oil feed water system, a dust collection water system, a paper manufacture water system, and a mineral refinement water system; a dispersant such as an organic or inorganic pigment, and an inorganic substance such as a soil and a mineral; a detergent builder; and a fiber treatment. Among them, the copolymer can be preferably used as a scale inhibitor, and can sufficiently exhibit effects of the present invention in a high-hardness water system. Therefore, such a scale inhibitor is especially useful industrially. As mentioned above, the scale inhibitor containing the (meth)acrylic acid copolymer is also part of the present invention.

If the above-mentioned (meth)acrylic acid copolymer is used in a water system, an amount to be added of the copolymer is appropriately determined depending on an application, water quality, or the like. For example, a lower limit of the amount to be added is 0.1 ppm, and an upper limit thereof is 100 ppm. More preferably, the lower limit is 1 ppm, and the upper limit is 50 ppm.

The above-mentioned (meth)acrylic acid copolymer can exhibit sufficient effects as the scale inhibitor of the present invention even if the copolymer is independently used. However, another additive usually used may be combined with the copolymer, if necessary. Examples of the another additive include one or more of a phosphorus compound and/or a polycarboxylic acid polymer such as polyacrylic acid (polyacrylate), polymaleic acid (polymaleate), acrylic acid copolymer, and a styrene-maleic acid copolymer. Other scale inhibitors, corrosion inhibitors, slime inhibitors, chelating agents, deoxidants, and the like may be used.

A method of scale inhibition using the above-mentioned scale inhibitor will hereinafter be described. The above-mentioned scale inhibitor may be added as it is into a water system such as a cooling water system and a boiler water system. If the above-mentioned scale inhibitor contains a component other than the above-mentioned (meth)acrylic acid copolymer, the copolymer and the component may be added separately. When the scale inhibitor is added into a water system, the scale inhibitor is preferably added together with a phosphorus compound and/or zinc salt, which makes it possible to enhance both effects of preventing a corrosion of an iron pipe used as a flow channel of the water system and preventing a scale adhesion. As the phosphoric acid compound, polymerized phosphoric acid (phosphate), phosphoric acid (phosphate), and phosphoric acid (phosphate) may be mentioned. As the zinc salt, zinc nitrate and zinc chloride may be mentioned. These compound(s) are used singly or in combination.

The scale inhibitor of the present invention is especially effective for scale inhibition of zinc phosphate, but can be used for scale inhibition of calcium carbonate, calcium phosphate, silicic acid soda, silica, iron salt, and the like, other than the zinc phosphate.

If the above-mentioned (meth)acrylic acid copolymer is used as a water treatment agent, the water treatment agent is added into a water system such as a cooling water system and a boiler water system. In this case, the (meth)acrylic acid copolymer may be added as it is, or a water treatment agent containing the (meth)acrylic acid copolymer and a component other than the copolymer may be added. A composition component and a compounding ratio of the compound other than the (meth)acrylic acid copolymer in the water treatment agent can be appropriately determined based on various components used for publicly known water treatment agents and compounding ratio thereof, unless effects of the present invention are sacrificed.

If the above-mentioned (meth)acrylic acid copolymer is used as a dispersant, the dispersant may be an aqueous dispersant. For example, a pigment agent, a cement dispersant, a dispersant of calcium carbonate, a dispersant of kaolin, and the like are preferred. Such a dispersant can exhibit an extremely excellent dispersibility which the (meth)acrylic acid copolymer originally has. Such a dispersant can be one having extremely high quality and high performance and excellent in stability without reduction in performance after storage for a long period or without impurity deposition during storage at a low temperature. A composition component and a compounding ratio of the compound other than the (meth)acrylic acid copolymer in the dispersant can be appropriately determined based on various components used for publicly known dispersants and compounding ratio thereof, unless effects of the present invention are sacrificed.

The (meth)acrylic acid copolymer of the present invention has the above-mentioned configurations. Therefore, the (meth)acrylic acid copolymer exhibits excellent chelating ability, dispersibility, and gel resistance, and thereby can be preferably used in various applications, for example, in a water treatment agent such as a scale inhibitor and a corrosion inhibitor, a dispersant, and a detergent builder.

### BEST MODE FOR CARRYING OUT THE INVENTION

The present invention will, hereinafter, be described in more detail with reference to Examples, but the present invention is not limited to these Examples. The term “%” represents “% by weight” unless otherwise specified.

In the following Examples and the Comparative Examples, a weight-average molecular weight and a value A (gel resistance value), a clay dispersibility for JIS test powders I Class 11, and a clay dispersibility for JIS test powders I Class 8 are determined in the above-mentioned manners. An ability for suppressing a zinc phosphate deposit was measured according to the following procedures.

### [Measurement of Ability for Suppressing a Zinc Phosphate Deposit]

Into a 225 mL screw top bottle were added desalted water, an aqueous solution of calcium chloride, a (co)polymer aqueous solution, an aqueous solution of zinc chloride, an aqueous solution of sodium hydrogencarbonate, and an aqueous solution of sodium phosphate in this order, and finally, an aqueous solution of 0.1N hydroxide to adjust pH. In this manner, prepared is a test solution 100 mL with pH of 8.6, a (co)polymer concentration of 3 mg/L on a solid matter equivalent basis, a calcium hardness of 100 mgCaCO₃/L, an M alkalinity of 100 mgCaCO₃/L, a phosphoric acid ion of 6.0 mgPO4³⁻/L, and a zinc ion of 3.5 mgZn²⁺/L. The bottle was sealed and put into a hot air dryer at 60° C. After 40 hours, the test solution was filtered with a filter having a pore size of 0.1 μm to analyze concentrations of residual phosphoric acid ions and residual zinc ions in the filtrate. A test solution obtained by removing the (co)polymer from the above-mentioned test solution is prepared as a blank. And the blank was measured for concentrations of residual phosphoric acid ions and residual zinc ions after the above operations. A ratio for suppressing a deposition is determined by the following formula.

Ratio for suppressing a depositon (%)=100×(R−Q)/(P−Q)

P: a total of charged phosphoric acid ion concentration and charged zinc ion concentration (mg/L)
Q: a total of residual phosphoric acid ion concentration and residual zinc ion concentration in the blank (mg/L)
R: a total of residual phosphoric acid ion concentration and residual zinc ion concentration (mg/L)

### EXAMPLE 1

Into a 2.5 L SUS separable flask equipped with a reflux condenser and a stirrer were charged demineralized water 175.0 g and Mohr's salt 0.0084 g, and then the mixture was heated at 90° C. under stirring to prepare a polymerization reaction system. Then, into the polymerization reaction system maintained at approximately 90° C. were added dropwise, under stirring, a 80% aqueous solution of acrylic acid (hereinafter, abbreviated as 80% AA) 328.5 g, 100% 2-hydroxyethyl methacrylate (hereinafter, abbreviated as 100% HEMA) 175.6 g, 48% sodium hydroxide (hereinafter, abbreviated as 48% NaOH) 15.2 g, 35% sodium hydrogensulfite (hereinafter, abbreviated as 35% SBS) 57.1 g (equivalent to 4.0 g to 1 mol of the monomer in the monomer composition), and a 15% aqueous solution of sodium persulfate (hereinafter, abbreviated as 15% NaPS (equivalent to 1.5 g to 1 mol of the monomer in the monomer composition) 50.0 g from separate drop nozzles to prepare a reaction solution. The 80% AA aqueous solution, the 100% HEMA, and the 48% NaOH were added dropwise for 180 minutes, the 35% SBS for 175 minutes, and the 15% NaPS for 190 minutes. The drop rate of each aqueous solution was constant and each aqueous solution was continuously added dropwise.

After the 15% NaPS had been added dropwise, the reaction solution was maintained (matured) at 90° C. for more 30 minutes to complete the polymerization. In this manner, a copolymer aqueous solution with a solid concentration of 59% was prepared. Table 1 shows measurement results of a weight-average molecular weight Mw, a gel resistance value A, and an ability for suppressing a zinc phosphate deposit of the copolymer. Table 2 shows measurement results of a clay dispersibility for JIS test powders I Class 11 and a clay dispersibility for JIS test powders I Class 8 of the copolymer.

The obtained copolymer aqueous solution was neutralized with sodium hydroxide, and from which water was removed under reduced pressure drying. Then, the resultant was measured for 1H-NMR (solvent: heavy water) using heavy water as a solvent to observe a peak of a methylene group at 2.4 ppm and a peak of a methine group at 3.0 ppm, the peaks being attributed to an introduction of a sulfonic acid group at a terminal of the main chain of the copolymer.

### EXAMPLE 2

Into a 2.5 L SUS separable flask equipped with a reflux condenser and a stirrer were charged demineralized water 175.0 g and Mohr's salt 0.0182 g, and then the mixture was heated at 90° C. under stirring to prepare a polymerization reaction system. Then, into the polymerization reaction system maintained at approximately 90° C. were added dropwise, under stirring, 80% AA 363.6 g, 100% HEMA 124.9 g, 48% NaOH 16.8 g, 35% SBS 85.7 g (equivalent to 6.0 g to 1 mol of the monomer in the monomer composition), and 15% NaPS 100.0 g (equivalent to 3.0 g to 1 mol of the monomer in the monomer composition) from separate drop nozzles to prepare a reaction solution. The 80% AA aqueous solution, the 100% HEMA, and the 48% NaOH were added dropwise for 180 minutes, the 35% SBS for 175 minutes, and the 15% NaPS for 185 minutes. The drop rate of each aqueous solution was constant and each aqueous solution was continuously added dropwise.

After the 15% NaPS had been added dropwise, the reaction solution was maintained (matured) at 90° C. for more 30 minutes to complete the polymerization. In this manner, a copolymer aqueous solution with a solid concentration of 54% was prepared. Table 1 shows measurement results of a weight-average molecular weight Mw, a gel resistance value A, and an ability for suppressing a zinc phosphate deposit of the copolymer. Table 2 shows measurement results of a clay dispersibility for JIS test powders I Class 11 and a clay dispersibility for JIS test powders I Class 8 of the copolymer.

The obtained copolymer aqueous solution was neutralized with sodium hydroxide, and from which water was removed under reduced pressure drying. Then, the resultant was measured for 1H-NMR (solvent: heavy water) using heavy water as a solvent to observe a peak of a methylene group at 2.4 ppm and a peak of a methine group at 3.0 ppm, the peaks being attributed to an introduction of a sulfonic acid group at a terminal of the main chain of the copolymer.

### EXAMPLE 3

Into a 2.5 L SUS separable flask equipped with a reflux condenser and a stirrer were charged demineralized water 175.0 g and Mohr's salt 0.0086 g, and then the mixture was heated at 90° C. under stirring to prepare a polymerization reaction system. Then, into the polymerization reaction system maintained at approximately 90° C. were added dropwise, under stirring, 80% AA 346.5 g, 100% HEMA 149.6 g, 48% NaOH 16.0 g, 35% SBS 68.6 g (equivalent to 4.8 g to 1 mol of the monomer in the monomer composition), and 15% NaPS 60.0 g (equivalent to 1.8 g to 1 mol of the monomer in the monomer composition) from separate drop nozzles to prepare a reaction solution. The 80% AA aqueous solution, the 100% HEMA, and the 48% NaOH were added dropwise for 180 minutes, the 35% SBS for 175 minutes, and the 15% NaPS for 185 minutes. The drop rate of each aqueous solution was constant and each aqueous solution was continuously added dropwise. After the 15% NaPS had been added dropwise, the reaction solution was maintained (matured) at 90° C. for more 30 minutes to complete the polymerization. In this manner, a copolymer aqueous solution with a solid concentration of 57% was prepared. Table 1 shows measurement results of a weight-average molecular weight Mw, a gel resistance value A, and an ability for suppressing a zinc phosphate deposit of the copolymer.

The obtained copolymer aqueous solution was neutralized with sodium hydroxide, and from which water was removed under reduced pressure drying.

Then, the resultant was measured for 1H-NMR (solvent: heavy water) using heavy water as a solvent to observe a peak of a methylene group at 2.4 ppm and a peak of a methine group at 3.0 ppm, the peaks being attributed to an introduction of a sulfonic acid group at a terminal of the main chain of the copolymer.

### EXAMPLE 4

Into a 2.5 L SUS separable flask equipped with a reflux condenser and a stirrer were charged demineralized water 161.7 g and Mohr's salt 0.0081 g, and then the mixture was heated at 90° C. under stirring to prepare a polymerization reaction system. Then, into the polymerization reaction system maintained at approximately 90° C. were added dropwise, under stirring, 80% AA 328.5 g, 100% 2-hydroxyethyl acrylate (hereinafter, abbreviated as 100% HEA) 156.7 g, 48% NaOH 15.2 g, 35% SBS 57.1 g (equivalent to 4.0 g to 1 mol of the monomer in the monomer composition), and 15% NaPS 50.0 g (equivalent to 1.5 g to 1 mol of the monomer in the monomer composition) from separate drop nozzles to prepare a reaction solution. The 80% AA aqueous solution, the 100% HEA, and the 48% NaOH were added dropwise for 180 minutes, the 35% SBS for 175 minutes, and the 15% NaPS for 190 minutes. The drop rate of each aqueous solution was constant and each aqueous solution was continuously added dropwise. After the 15% NaPS had been added dropwise, the reaction solution was maintained (matured) at 90° C. for more 30 minutes to complete the polymerization. In this manner, a copolymer aqueous solution with a solid concentration of 59% was prepared. Table 1 shows measurement results of a weight-average molecular weight Mw, a gel resistance value A, and an ability for suppressing a zinc phosphate deposit of the copolymer.

The obtained copolymer aqueous solution was neutralized with sodium hydroxide, and from which water was removed under reduced pressure drying. Then, the resultant was measured for 1H-NMR (solvent: heavy water) using heavy water as a solvent to observe a peak of a methylene group at 2.4 ppm and a peak of a methine group at 3.0 ppm, the peaks being attributed to an introduction of a sulfonic acid group at a terminal of the main chain of the copolymer.

### EXAMPLE 5

Into a 2.5 L SUS separable flask equipped with a reflux condenser and a stirrer were charged demineralized water 276.1 g and Mohr's salt 0.0101 g, and then the mixture was heated at 90° C. under stirring to prepare a polymerization reaction system. Then, into the polymerization reaction system maintained at approximately 90° C. were added dropwise, under stirring, 80% AA 180.0 g, 100% HEMA 390.3 g, 48% NaOH 8.3 g, 35% SBS 57.1 g (equivalent to 4.0 g to 1 mol of the monomer in the monomer composition), and 15% NaPS 50.0 g (equivalent to 1.5 g to 1 mol of the monomer in the monomer composition) from separate drop nozzles to prepare a reaction solution. The 80% AA aqueous solution, the 100% HEMA, and the 48% NaOH were added dropwise for 180 minutes, the 35% SBS for 175 minutes, and the 15% NaPS for 190 minutes. The drop rate of each aqueous solution was constant and each aqueous solution was continuously added dropwise.

After the 15% NaPS had been added dropwise, the reaction solution was maintained (matured) at 90° C. for more 30 minutes to complete the polymerization. In this manner, a copolymer aqueous solution with a solid concentration of 59% was prepared. Table 1 shows measurement results of a weight-average molecular weight Mw, a gel resistance value A, and an ability for suppressing a zinc phosphate deposit of the copolymer.

The obtained copolymer aqueous solution was neutralized with sodium hydroxide, and from which water was removed under reduced pressure drying. Then, the resultant was measured for 1H-NMR (solvent: heavy water) using heavy water as a solvent to observe a peak of a methylene group at 2.4 ppm and a peak of a methine group at 3.0 ppm, the peaks being attributed to an introduction of a sulfonic acid group at a terminal of the main chain of the copolymer.

### EXAMPLE 6

Into a 2.5 L SUS separable flask equipped with a reflux condenser and a stirrer were charged demineralized water 350.0 g and Mohr's salt 0.0185 g, and then the mixture was heated at 90° C. under stirring to prepare a polymerization reaction system. Then, into the polymerization reaction system maintained at approximately 90° C. were added dropwise, under stirring, 80% AA 657.0 g, 100% HEMA 351.3 g, 48% NaOH 30.4 g, 35% SBS 171.3 g (equivalent to 6.0 g to 1 mol of the monomer in the monomer composition), and 15% NaPS 200.0 g (equivalent to 3.0 g to 1 mol of the monomer in the monomer composition) from separate drop nozzles to prepare a reaction solution. The 80% AA aqueous solution, the 100% HEMA, and the 48% NaOH were added dropwise for 180 minutes, the 35% SBS for 175 minutes, and the 15% NaPS for 190 minutes. The drop rate of each aqueous solution was constant and each aqueous solution was continuously added dropwise.

After the 15% NaPS had been added dropwise, the reaction solution was maintained (matured) at 90° C. for more 30 minutes to complete the polymerization. In this manner, a copolymer aqueous solution with a solid concentration of 55% was prepared. Table 1 shows measurement results of a weight-average molecular weight Mw, a gel resistance value A, and an ability for suppressing a zinc phosphate deposit of the copolymer. Table 2 shows measurement results of a clay dispersibility for JIS test powders I Class 11 and a clay dispersibility for JIS test powders I Class 8 of the copolymer. The obtained copolymer aqueous solution was neutralized with sodium hydroxide, and from which water was removed under reduced pressure drying. Then, the resultant was measured for 1H-NMR (solvent: heavy water) using heavy water as a solvent to observe a peak of a methylene group at 2.4 ppm and a peak of a methine group at 3.0 ppm, the peaks being attributed to an introduction of a sulfonic acid group at starting and ending terminals of the main chain of the copolymer.

### EXAMPLE 7

Into a 2.5 L SUS separable flask equipped with a reflux condenser and a stirrer were charged demineralized water 350.0 g and Mohr's salt 0.0167 g, and then the mixture was heated at 90° C. under stirring to prepare a polymerization reaction system. Then, into the polymerization reaction system maintained at approximately 90° C. were added dropwise, under stirring, 80% AA 847.8 g, 100% HEMA 75.5 g, 48% NaOH 39.3 g, 35% SBS 142.8 g (equivalent to 5.0 g to 1 mol of the monomer in the monomer composition), and 15% NaPS 133.3 g (equivalent to 2.0 g to 1 mol of the monomer in the monomer composition) from separate drop nozzles to prepare a reaction solution. The 80% AA aqueous solution, the 100% HEA, and the 48% NaOH were added dropwise for 180 minutes, the 35% SBS for 175 minutes, and the 15% NaPS for 190 minutes. The drop rate of each aqueous solution was constant and each aqueous solution was continuously added dropwise.

After the 15% NaPS had been added dropwise, the reaction solution was maintained (matured) at 90° C. for more 30 minutes to complete the polymerization. In this manner, a copolymer aqueous solution with a solid concentration of 53% was prepared. Table 2 shows measurement results of a weight-average molecular weight Mw, a gel resistance value A, a clay dispersibility for JIS test powders I Class 11 and a clay dispersibility for JIS test powders I Class 8 of the copolymer. The obtained copolymer aqueous solution was neutralized with sodium hydroxide, and from which water was removed under reduced pressure drying. Then, the resultant was measured for 1H-NMR (solvent: heavy water) using heavy water as a solvent to observe a peak of a methylene group at 2.4 ppm and a peak of a methine group at 3.0 ppm, the peaks being attributed to an introduction of a sulfonic acid group at starting and ending terminals of the main chain of the copolymer.

### EXAMPLE 8

Into a 2.5 L SUS separable flask equipped with a reflux condenser and a stirrer were charged demineralized water 350.0 g and Mohr's salt 0.0395 g, and then the mixture was heated at 90° C. under stirring to prepare a polymerization reaction system. Then, into the polymerization reaction system maintained at approximately 90° C. were added dropwise, under stirring, 80% AA 657.0 g, 100% HEMA 351.3 g, 48% NaOH 30.4 g, 35% SBS 285.7 g (equivalent to 10.0 g to 1 mol of the monomer in the monomer composition), and 15% NaPS 200.0 g (equivalent to 3.0 g to 1 mol of the monomer in the monomer composition) from separate drop nozzles to prepare a reaction solution. The 80% AA aqueous solution, the 100% HEMA, and the 48% NaOH were added dropwise for 180 minutes, the 35% SBS for 175 minutes, and the 15% NaPS for 190 minutes. The drop rate of each aqueous solution was constant and each aqueous solution was continuously added dropwise.

After the 15% NaPS had been added dropwise, the reaction solution was maintained (matured) at 90° C. for more 30 minutes to complete the polymerization. In this manner, a copolymer aqueous solution with a solid concentration of 54% was prepared. Table 1 shows measurement results of a weight-average molecular weight Mw, a gel resistance value A, and an ability for suppressing a zinc phosphate deposit of the copolymer. The obtained copolymer aqueous solution was neutralized with sodium hydroxide, and from which water was removed under reduced pressure drying. Then, the resultant was measured for 1H-NMR (solvent: heavy water) using heavy water as a solvent to observe a peak of a methylene group at 2.4 ppm and a peak of a methine group at 3.0 ppm, the peaks being attributed to an introduction of a sulfonic acid group at starting and ending terminals of the main chain of the copolymer.

### COMPARATIVE EXAMPLE 1

Into a 2.5 L SUS separable flask equipped with a reflux condenser and a stirrer were charged demineralized water 178.0 g and Mohr's salt 0.0242 g, and then the mixture was heated at 90° C. under stirring to prepare a polymerization reaction system. Then, into the polymerization reaction system maintained at approximately 90° C. were added dropwise, under stirring, 80% AA 450.0 g, 48% NaOH 20.8 g, 35% SBS 57.1 g (equivalent to 4.0 g to 1 mol of the monomer in the monomer composition), and 15% NaPS 66.7 g (equivalent to 2.0 g to 1 mol of the monomer in the monomer composition) from separate drop nozzles to prepare a reaction solution. The 80% AA aqueous solution, the 80% AA, and the 48% NaOH were added dropwise for 180 minutes, the 35% SBS for 175 minutes, and the 15% NaPS for 190 minutes. The drop rate of each aqueous solution was constant and each aqueous solution was continuously added dropwise.

After the 15% NaPS had been added dropwise, the reaction solution was maintained (matured) at 90° C. for more 30 minutes to complete the polymerization. After completion of the polymerization, the above-mentioned reaction solution was cooled and neutralized by adding dropwise 48% NaOH 375.0 g little by little while stirring the solution. In this way, an aqueous solution of sodium polyacrylate with a solid concentration of 45%, and a final neutralization degree of 95% by mole was prepared. Table 1 shows measurement results of a weight-average molecular weight Mw, a gel resistance value A, and an ability for suppressing a zinc phosphate deposit of the copolymer. Table 2 shows measurement results of a clay dispersibility for JIS test powders I Class 11 and a clay dispersibility for JIS test powders I Class 8 of the copolymer.

Water was removed from the obtained copolymer aqueous solution under reduced pressure drying. Then, the resultant was measured for 1H-NMR (solvent: heavy water) using heavy water as a solvent to observe a peak of a methylene group at 2.4 ppm and a peak of a methine group at 3.0 ppm, the peaks being attributed to an introduction of a sulfonic acid group at a terminal of the main chain of the polymer.

### COMPARATIVE EXAMPLE 2

Into a 2.5 L SUS separable flask equipped with a reflux condenser and a stirrer were charged demineralized water 292.0 g, and then the mixture was heated to boiling-point refluxing state under stirring to prepare a polymerization reaction system. Then, into the boiling-point refluxing state polymerization reaction system were added dropwise, under stirring, 80% AA 36.5 g, 37% sodium acrylate (hereinafter, abbreviated as 37% SA) 926.0 g, 100% HEMA 123.6 g, 15% NaPS 66.7 g (equivalent to 2.0 g to 1 mol of the monomer in the monomer composition), and 35% hydrogen peroxide (hereinafter, abbreviated as 35% HP) 71.4 g (equivalent to 5.0 g to 1 mol of the monomer in the monomer composition) from separate drop nozzles to prepare a reaction solution. The 80% AA aqueous solution, the 37% SA, 100% HEMA, and the 35% HP were added dropwise for 180 minutes, the 15% NaPS for 190 minutes. The drop rate of each aqueous solution was constant and each aqueous solution was continuously added dropwise.

After the 15% NaPS had been added dropwise, the reaction solution was maintained (matured) to boiling-point refluxing state for more 30 minutes to complete the polymerization. In this way, a copolymer aqueous solution with a solid concentration of 35%, and a final neutralization degree of 90% by mole was prepared. Table 1 shows measurement results of a weight-average molecular weight Mw, a gel resistance value A, and an ability for suppressing a zinc phosphate deposit of the copolymer.

Water was removed from the obtained copolymer aqueous solution under reduced pressure drying. Then, the resultant was measured for 1H-NMR (solvent: heavy water) using heavy water as a solvent to observe no peak attributed from an introduction of a sulfonic acid group at a terminal of the main chain of the copolymer.

### COMPARATIVE EXAMPLE 3

Into a 2.5 L SUS separable flask equipped with a reflux condenser and a stirrer were charged demineralized water 380.0 g, and then the mixture was heated to boiling-point refluxing state under stirring to prepare a polymerization reaction system. Then, into the boiling-point refluxing state polymerization reaction system were added dropwise, under stirring, 80% AA 42.4 g, 37% SA 1076.9 g, 100% HEMA 37.7 g, 15% NaPS 83.4 g (equivalent to 2.5 g to 1 mol of the monomer in the monomer composition), and 35% HP 71.4 g (equivalent to 5.0 g to 1 mol of the monomer in the monomer composition) from separate drop nozzles to prepare a reaction solution. The 80% AA aqueous solution, the 37% SA, 100% HEMA, and the 35% HP were added dropwise for 180 minutes, the 15% NaPS for 190 minutes. The drop rate of each aqueous solution was constant and each aqueous solution was continuously added dropwise.

After the 15% NaPS had been added dropwise, the reaction solution was maintained (matured) to boiling-point refluxing state for more 30 minutes to complete the polymerization. In this way, a copolymer aqueous solution with a solid concentration of 30%, and a final neutralization degree of 90% by mole was prepared. Table 1 shows measurement results of a weight-average molecular weight Mw, a gel resistance value A, and an ability for suppressing a zinc phosphate deposit of the copolymer.

Water was removed from the obtained copolymer aqueous solution under reduced pressure drying. Then, the resultant was measured for 1H-NMR (solvent: heavy water) using heavy water as a solvent to observe no peak attributed from an introduction of a sulfonic acid group at a terminal of the main chain of the copolymer.

TABLE 1

| | | Sulfonic acid | Weight- | | |
|---|---|---|---|---|---|
| | | group at a | average | | Ratio for |
| | Composition ratio | terminal of a | molecular | Gel resistance | suppressing a |
| | (% by mol) | (co)polymer | weight Mw | value A | deposition (%) |
| Example 1 | AA/HEMA = 73/27 | Existence | 14000 | 500 | 99 |
| Example 2 | AA/HEMA = 81/19 | Existence | 8000 | 140 | 100 |
| Example 3 | AA/HEMA = 77/23 | Existence | 11000 | 330 | 100 |
| Example 4 | AA/HEA = 73/27 | Existence | 11000 | 250 | 99 |
| Example 5 | AA/HEMA = 40/60 | Existence | 15000 | 330 | 97 |
| Example 6 | AA/HEMA = 73/27 | Existence | 9000 | 600 | 99 |
| Example 8 | AA/HEMA = 73/27 | Existence | 5000 | 1000 | 91 |
| Comparative | AA = 100 | Existence | 10000 | 0.5 | 0 |
| Example 1 | | | | | |
| Comparative | AA/HEMA = 81/19 | Non existence | 11000 | 4 | 73 |
| Example 2 | | | | | |
| Comparative | AA/HEMA = 94/6 | Non existence | 10000 | 1.2 | 34 |
| Example 3 | | | | | |

TABLE 2

| | | | | | Clay | Clay |
|---|---|---|---|---|---|---|
| | | Sulfonic acid | Weight- | | dispersibility | dispersibility |
| | | group at a | average | Gel | for JIS test | for JIS test |
| | Composition ratio | terminal of a | molecular | resistance | powders I | powders I |
| | (% by mol) | (co)polymer | weight Mw | value A | Class 8 | Class 11 |
| Example 1 | AA/HEMA = 73/27 | Existence | 14000 | 500 | 1.284 | 0.304 |
| Example 2 | AA/HEMA = 81/19 | Existence | 8000 | 140 | 1.214 | 0.258 |
| Example 6 | AA/HEMA = 73/27 | Existence | 9000 | 600 | 0.993 | 0.231 |
| Example 7 | AA/HEMA = 94/6 | Existence | 9000 | 20 | 0.892 | 0.607 |
| Comparative | AA = 100 | Existence | 10000 | 0.5 | 0.955 | 0.518 |
| Example 1 | | | | | | |

### INDUSTRIAL APPLICABILITY

The (meth)acrylic acid copolymer of the present invention has the above-mentioned configurations. Therefore, the (meth)acrylic acid copolymer exhibits excellent chelating ability, dispersibility, and gel resistance, and thereby can be preferably used in various applications, for example, in a water treatment agent such as a scale inhibitor and a corrosion inhibitor, a dispersant, and a detergent builder.

The present application claims priority to Japanese Patent Application No. 2005-104257 filed in Japan on Mar. 31, 2005, entitled “(METH)ACRYLIC ACID COPOLYMER, METHOD FOR THE SAME, AND APPLICATION THEREOF”, and Japanese Patent Application No. 2005-363294 filed in Japan on Dec. 16, 2005, entitled “(METH)ACRYLIC ACID COPOLYMER, METHOD FOR PRODUCING THE SAME, AND APPLICATION THEREOF”, the entire contents of which are herein incorporated by reference.

1. A (meth)acrylic acid copolymer having a constitutional unit (a) derived from a (meth)acrylic acid monomer (A) represented by a general formula (1) and a constitutional unit (b) derived from a hydroxyalkyl (meth)acrylate monomer (B) represented by a general formula (2),
wherein the copolymer has a sulfonic acid (sulfonate) group, and a value A of 10 or more, the value A being defined by a formula (1): A=1/(Abs−Abs0) 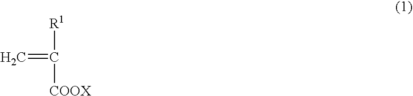
in the formula, R¹ represents a hydrogen atom or a methyl group, and X represents a hydrogen atom, a metallic atom, an ammonium group, or an organic amine group; 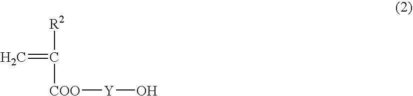
in the formula, R² represents a hydrogen atom or a methyl group, and Y represents an alkylene group containing 1 to 4 carbon atoms.

2. A (meth)acrylic acid copolymer having a constitutional unit (a) derived from a (meth)acrylic acid monomer (A) represented by a general formula (1) and a constitutional unit (b) derived from a hydroxyalkyl (meth)acrylate monomer (B) represented by a general formula (2),
wherein the copolymer has a sulfonic acid (sulfonate) group and a clay dispersibility for JIS test powders I Class 11 of 0.55 or more, or a clay dispersibility for JIS test powders I Class 8 of 0.97 or more in an aqueous solution with a calcium hardness of 200 mgCaCO₃/L, 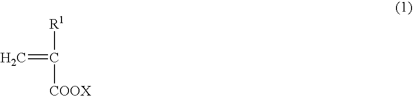
in the formula, R¹ represents a hydrogen atom or a methyl group, and X represents a hydrogen atom, a metallic atom, an ammonium group, or an organic amine group; 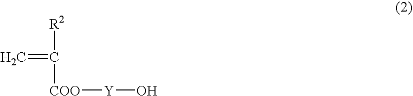
in the formula, R² represents a hydrogen atom or a methyl group, and Y represents an alkylene group containing 1 to 4 carbon atoms.

3. The (meth)acrylic acid copolymer according to claim 1,
wherein the value A is 100 or more.

4. The (meth)acrylic acid copolymer according to claim 1,
wherein the copolymer has the sulfonic acid group at least one terminal of the main chain.

5. The (meth)acrylic acid copolymer according to claim 1,
wherein the copolymer has the constitutional units (a) and (b) such that a ratio of the constitutional unit (a) to the constitutional unit (b) is 30 to 95% by mole to 5 to 70% by mole.

6. A method for producing the (meth)acrylic acid copolymer according to claim 1,
wherein an aqueous solution upon completion of a polymerization reaction has a solid concentration of 40% by weight or more.

7. A method for producing the (meth)acrylic acid copolymer according to claim 1,
wherein the method comprises a process for performing a polymerization reaction using sulfite.

8. A scale inhibitor containing the (meth)acrylic acid copolymer according to claim 1.

9. The (meth)acrylic acid copolymer according to claim 2, wherein the copolymer has the sulfonic acid group at least one terminal of the main chain.

10. The (meth)acrylic acid copolymer according to claim 3, wherein the copolymer has the sulfonic acid group at least one terminal of the main chain.

11. The (meth)acrylic acid copolymer according to claim 2, wherein the copolymer has the constitutional units (a) and (b) such that a ratio of the constitutional unit (a) to the constitutional unit (b) is 30 to 95% by mole to 5 to 70% by mole.

12. The (meth)acrylic acid copolymer according to claim 3, wherein the copolymer has the constitutional units (a) and (b) such that a ratio of the constitutional unit (a) to the constitutional unit (b) is 30 to 95% by mole to 5 to 70% by mole.

13. The (meth)acrylic acid copolymer according to claim 4, wherein the copolymer has the constitutional units (a) and (b) such that a ratio of the constitutional unit (a) to the constitutional unit (b) is 30 to 95% by mole to 5 to 70% by mole.

14. A method for producing the (meth)acrylic acid copolymer according to claim 2, wherein an aqueous solution upon completion of a polymerization reaction has a solid concentration of 40% by weight or more.

15. A method for producing the (meth)acrylic acid copolymer according to claim 3, wherein an aqueous solution upon completion of a polymerization reaction has a solid concentration of 40% by weight or more.

16. A method for producing the (meth)acrylic acid copolymer according to claim 4, wherein an aqueous solution upon completion of a polymerization reaction has a solid concentration of 40% by weight or more.

17. A method for producing the (meth)acrylic acid copolymer according to claim 5, wherein an aqueous solution upon completion of a polymerization reaction has a solid concentration of 40% by weight or more.

19. A method for producing the (meth)acrylic acid copolymer according to claim 2, wherein the method comprises a process for performing a polymerization reaction using sulfite.

20. A method for producing the (meth)acrylic acid copolymer according to claim 3, wherein the method comprises a process for performing a polymerization reaction using sulfite.
